(19) United States
(12) Patent Application Publication
(10) Pub. No.: US 2009/0068394 A1
(43) Pub. Date: Mar. 12, 2009

(54) NONWOVEN HOOK-AND-LOOP FASTENER FOR A GARMENT

(75) Inventors: Frederic Noelle, St. Nazaire Les Eymes (FR); Sophie Roussel, Dardilly (FR)

Correspondence Address: PEARNE & GORDON LLP, 1801 EAST 9TH STREET, SUITE 1200, CLEVELAND, OH, 44114-3108, US

(73) Assignee: RIETER PERFOJET, Montbonnot, FR (FR)

(21) Appl. No.: 12/279,572

(22) PCT Filed: Feb. 6, 2007
(86) PCT No.: PCT/FR2007/000210

§ 371 Date: Nov. 14, 2008

(30) Foreign Application Priority Data
Feb. 17, 2006 (FR) 0601394

(51) Int. Cl. B32B 3/06; C08F 110/06; C08F 110/02

(52) U.S. Cl. 428/100; 526/351; 526/352

(57) ABSTRACT

The use, as the female part of a hook-and-loop fastener, of a nonwoven (25) which has openings, on the lateral walls of which the entangled filaments are intact.

The present invention relates to hook-and-loop fasteners and to garments which are fastened by fasteners of this kind.

Fastening systems having. strips of the hook-and-loop type are widely employed in various fields of application such as hygiene, clothing and the motor industry for example. They are made up of a male portion comprising hooks and a female portion comprising loops to which the hooks on the male part become attached. Since the female part is often made of a flexible material, it is generally counter-bonded or laminated to a more rigid support.

In the hygiene sector, in the case of disposable products with a limited period of use, there is a need for low-price areas of attachment which are less expensive than knitted or woven textile products. Baby diapers and their equivalents for adult incontinence are examples of applications which need modestly priced areas of attachment that can be opened and closed a limited number of times, typically three times, before being thrown away. Areas of attachment for hygiene purposes must be very soft to the touch and in certain cases, such as Baby diapers, must be capable of being printed on their reverse side as a decoration.

Now a nonwoven structure has been found—and it is the subject of the present invention—which is particularly well-suited to producing areas of attachment, or a female part, for applications in which the number of times the hook-and-loop system is opened and closed is limited, such as, for example, in the field of hygiene.

The object of the invention is therefore the use, as the female part of a hook-and-loop fastener, of a nonwoven:
which is made up of filaments;
the cohesion of which is provided solely by the entanglement of the filaments;
which has a thickness of between 0.1 and 2.0 mm, preferably between 0.25 mm and 1.20 mm;
which has a basis weight of between 10 and 100 g/m², preferably between 15 and 40 g/m²; and
which has openings numbering between 3 and 80 per cm², preferably between 4 and 40 per cm², on the lateral walls of which the entangled filaments are intact.

The female parts of fasteners according to the invention have excellent attachment to most of the known hooks. It is also possible to reposition the hooks a number of times at the same place while still presenting good strength characteristics. The feel is textile and soft and particularly suits the expectations of the consumers of hygiene products such as nappies for babies. When used in products for hygiene purposes, the nonwovens according to the invention also have the advantage, compared to commercial products, of not needing lamination or counter-bonding to a printed film. In actual fact, printing can be carried out directly onto the reverse side of the nonwoven by known techniques such as flexography. And another advantage of the nonwovens according to the invention is that they are inexpensive, less expensive than textiles with loops such as knitted fabrics or other products which are similar to textiles.

The object of the invention is the use, as the female part of a hook-and-loop fastener, of a nonwoven made up of continuous filaments of thermoplastic materials such as, for example, PP, PE, PET, PA, PLA, etc. Said filaments have, in particular, a diameter of between 5 and 50 microns, and preferably between 10 and 30 microns. They are disposed in a complex three-dimensional network which has the feature of not having any point at which the filaments are fused or bonded to one another. In other words, the cohesion of the filaments is brought about solely by their entanglement, a fact which makes it possible to achieve maximum efficiency of attachment of the hooks to the fibrous network. Most of the length of the filaments can be used, which makes a particularly efficient area of attachment. The presence of openings improves its efficiency. Said openings extend from one face towards the other. They may be of square, rectangular, circular or elliptical geometrical shape. They terminate in an aperture at the opposite face. The openings are between 3 and 80 per cm², and preferably between 4 and 40 per cm². They are delimited and separated from one another by the fibrous network. They are preferably ordered in a staggered manner or aligned, but may also be disposed in a random manner.

Generally speaking, these openings are not absolutely cylindrical, but instead are conical in shape. The angle of the cone is between 5 and 45° when observed using an optical microscope with a magnification of 20 times. The walls of the cones are made up of the openings of uncut, unbroken entangled filaments. The filaments are intact on the lateral walls.

Unlike perforations which would weaken the nonwoven, these openings, which are obtained without removing material and by pushing back the material in the gaps between the openings, reinforce the power of attachment of the hooks to the female part by increasing the quantity of material in the gaps, but without increasing the average basis weight. The female part is made more effective without being more expensive.

These openings have at least two main dimensions in the plane of the nonwoven, and these may be referred to as the “height” and “width”.

The smallest dimension and the largest dimension are between 0.3 and 3.5 mm, and preferably between 0.5 and 3.0 mm. In certain specific cases, the smallest and largest dimensions are identical. That is the case, for example, with the square.

The pitch of the openings, which is defined by the median-axis-to-median-axis distance between two consecutive openings, is usually between 1.2 times and 3.0 times the smallest dimension of the openings, and preferably between 1.3 times and 2.5 times said smallest dimension.

The openings are most easily obtained when their largest dimension is at least equal to the thickness of the nonwoven and at most equal to 3 times the said thickness.

The shearing force provided by the female part in tests with hooks is a minimum of 10 N, and preferably a minimum of 13 N.

The peeling force in tests with hooks is a minimum of 10 N, and preferably a minimum of 15 N.

The nonwovens used in accordance with the invention are transparent and can be printed on their reverse side, and the printing is visible on the right side, a fact which constitutes a great advantage compared to the nonwovens currently marketed, which are difficult to print on and whose transparency is less good than that of the nonwovens according to the invention.

The nonwovens used in accordance with the invention are produced on a machine which is marketed by the Rieter Perfojet company under the trade name “Spunjet”. The curtain of filaments is formed by a spunbond tower and is consolidated by the hydroentanglement process.

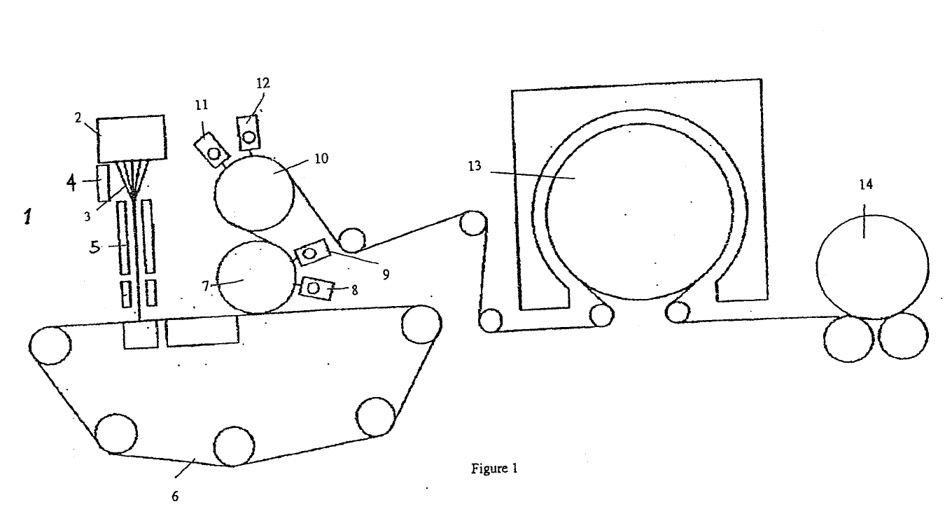

This machine, which is shown diagrammatically in FIG. 1, comprises a spunbond tower 1 comprising, from top to bottom, a spinning beam 2 which delivers a curtain of continuous filaments 3 made of thermoplastic polymers. The filaments are cooled by a cooling device 4 and drawn by a drawing unit 5 and then laid down on a conveyer belt 6 as a non-consolidated sheet of continuous filaments. Disposed downstream of the spunbond tower, and preferably tangent to the conveyer belt 6, is a first cylinder for consolidation by jets of water, as described in WO/FR03/01101 which forms part of the present memorandum. The first cylinder 7 is formed by a drum comprising a fixed cylindrical body with a perforated lateral surface. This unit is surrounded by a jacket with holes which is driven in rotation in relation to the axis of the cylindrical body. The cylindrical body has means which are intended to set up a negative pressure inside the body. A jacket is slipped on over the said cylinder. The said jacket possesses randomly disposed micro-perforations with 5 to 20% opening and having a diameter ranging from 50 to 500 microns, and preferably between 200 and 300 microns. It has a thickness of between 0.1 and 0.6 mm, and preferably between 0.2 and 0.4 mm.

The cylinder 7 is tangent to the conveyer 6. The sheet of continuous filaments is transferred to the drum 7, on which it is consolidated by the action of two injectors 8 and 9 which deliver jets of water of 120 microns in diameter at pressures of 30 to 300 bars. The sheet which has been consolidated in this way is transferred to a second drum 10 covered with jackets which are intended for producing three-dimensional structures, and preferably perforations, within the nonwovens. The action of producing openings in the sheet of filaments is the result of the action of the jets of water delivered by the injectors 11 and 12 and of the supports, whose three-dimensional surface has been designed to generate small openings in the sheet of filaments. The jackets are of different types.

These are metal or plastic fabrics whose threads have a diameter ranging from 0.4 mm to 0.9 mm, and preferably between 0.5 and 0.8 mm, in warp, and ranging from 0.3 mm to 1 mm, and preferably between 0.4 mm and 0.9 mm, in weft. These fabrics have a linen, serge-like or herring-bone pattern. The texture of these fabrics is between 5×5 threads per centimetre for 10×10 threads per centimetre. The said threads have a cylindrical or rectangular cross-section. The void fraction of these fabrics is between 20% and 40%, and preferably between 22% and 30%. The permeability of these fabrics to air is between 500 CFM and 1000 CFM.

The surfaces in question may be ones which are engraved by laser action or perforated ones on which raised metal deposits have been produced. They may also be three- dimensional surfaces which are obtained by chemical action of metal materials. These raised surfaces may be of any shape: round, oval, rectangular, hexagonal or other shape. The said shapes possess sharp or rounded angles of 10 to 90°, according to the geometry. The heights of these raised portions are from 1 to 3 mm. The cross-sections have dimensions of between 0.5 and 2.5 mm. These raised parts are surrounded by perforations 0.3 to 0.8 mm in diameter. This thickness of this network of perforations is between 0.3 and 0.8 mm.

The fabrics in question may be metal or plastic ones having on the surface, hard raised portions made of polymers. These raised portions are generally drops of polymers of rounded shape with diameters of between 1.4 and 4 mm, and preferably between 2 mm and 3 mm. The height of these depositions is between 0.5 mm and 1.8 mm. The density of these raised portions is between 1 and 20 drops per square centimetre, and preferably between 5 and 10 drops per square centimetre. The drops are integrated in the surface of a metal or plastic fabric. The threads of these fabrics have a diameter ranging from 0.1 to 0.4 mm, and preferably between 0.15 and 0.3 mm, in warp, and ranging from 0.2 mm to 0.4 mm, and preferably between 0.25 mm and 0.35 mm, in weft. These threads have a linen, serge-like or herring-bone pattern. The texture of these fabrics is between 10×10 threads per centimetre for 40×20 threads per centimetre. The said threads have a rectangular, cylindrical or hexagonal cross-section. The void fraction of these fabrics is between 10% and 30%, and preferably between 15% and 25%. The permeability of these fabrics to air is between 400 CFM and 600 CFM.

The action of water jets combined with these cylinders displaces the filaments until openings are formed.

The injectors 11 and 12 deliver jets of 120 microns at pressures of 50 to 300 bars. Suction devices, which are not represented, make possible to evacuate the excess water from the injectors via the interior of the drums, and also to pre-dry the nonwoven before it is transferred to the dryer 13 which effects drying by air that passes through. The nonwoven is then rolled by a winder 14.

The female part can be used in the usual way in the form of a strip which is bonded, or fixed in some other way, to a garment, and is intended to cooperate with a strip forming the male part. But according to one particularly advantageous embodiment, the object of the invention is also a garment made of nonwoven, and very specifically, a diaper which is fastened by a hook-and-loop fastener and is characterised in that the female part of the fastener is constituted by the right-side face of a self-clothing part of the garment, which is one of the faces of a nonwoven as used in accordance with the invention.

A “clothing part” is a part whose main function is to directly or indirectly cover nakedness, the reverse-side face being in contact with the skin or with an undergarment when the garment is being worn.

The use of the nonwoven according to the invention, both as a self-clothing part of the garment and as the female part of the hook-and-loop fastener, has determining advantages:
it is no longer necessary to stitch, bond or otherwise fix a strip that forms the female part onto part of the garment. The cost of making the diaper is thereby considerably reduced;
when the diaper is fastened, the male element does not have to be fitted precisely onto a narrow strip constituting a female part, since a very large part of the right-side face of the garment itself is capable of constituting the female part. Fastening the disposable nappy or other garment requires less care. If the fastening operation fails at a place at which the female part has been damaged or excessively stressed by successive undoing and fastening operations, all that is needed is to cause the male part to cooperate with another place on that clothing part of the garment which constitutes to the female part;
and added to these advantages is the fact that the female part is soft to the touch, as is appropriate for a clothing part.

According to one, greatly preferred embodiment, a decorative is affixed to the reverse-side face of the nonwoven. The decorative motif is thus protected from external influences and from possible deterioration as a result of inopportune operation of the male part, and yet it is clearly visible because the nonwoven according to the invention is transparent.

According to the invention, “garment” is understood to mean not only the garments themselves, such as, in particular, diaper or textile incontinence products, but also the accessories of said garments and, exceptionally, when a decorative motif is affixed to the reverse-side face, the hook-and-loop fastener itself. There is obtained, for the first time, a hook-and-loop fastener whose female part comprises a decoration on the inactive face in such a way that the said decoration, although protected, is visible when the male part is separated from the female part, or is even visible when the male part is affixed to the female part if care is taken to ensure that the male part is made up of a transparent material.

Particularly in a diaper, the right-side surface of the clothing part of the garment has a surface area which is more than two times, and preferably more than five times, larger than the surface area of the male part of the fastener.

FIG. 1 is a diagram of an installation which makes it possible to manufacture the nonwoven used in accordance with the invention;

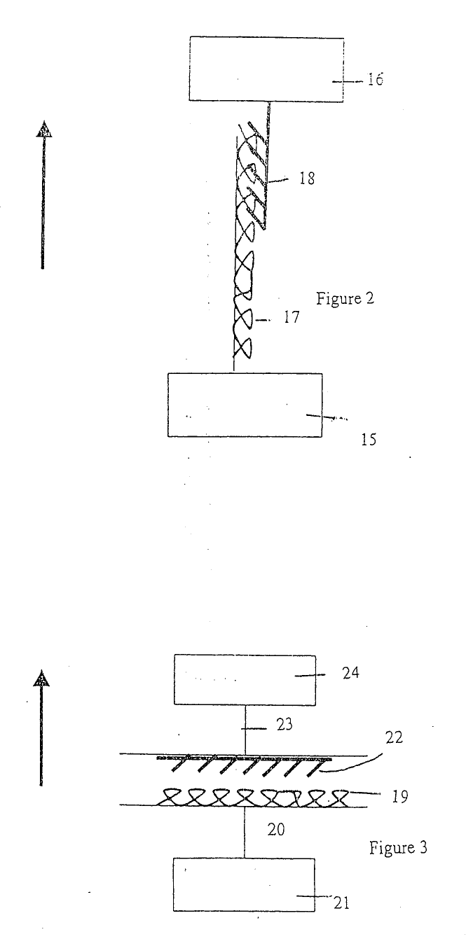

FIGS. 2 and 3 illustrate the devices for measuring the shearing force and the peeling force, respectively;

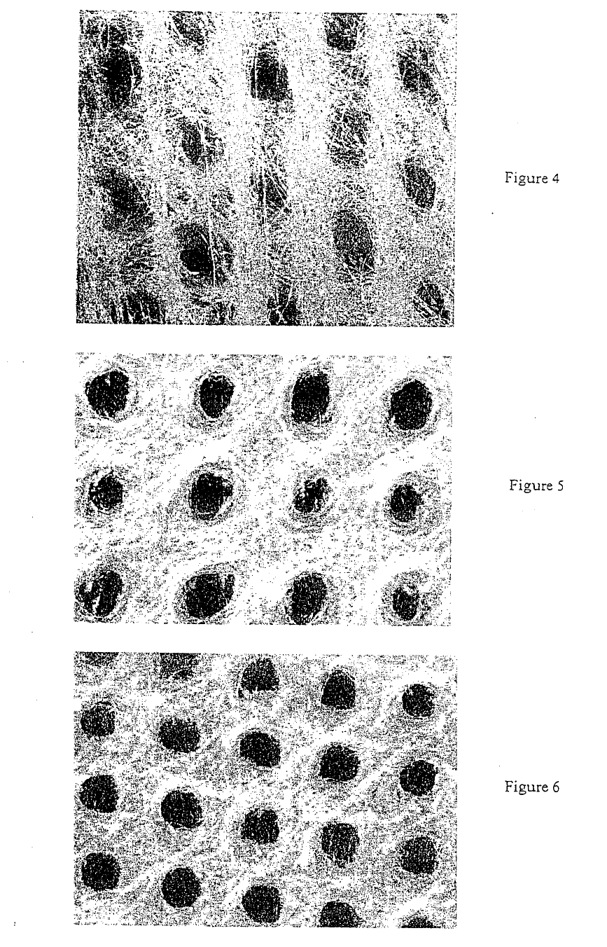

FIGS. 4 to 7 are views, using a microscope with a magnification of 20 times, of female parts according to the invention of a hook-and-loop fastener; and

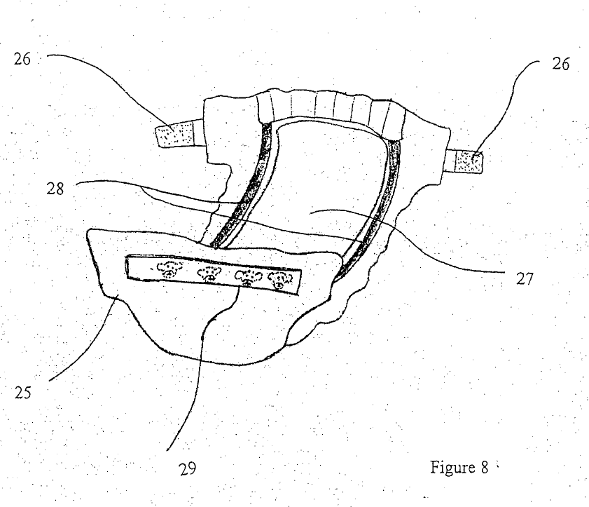

FIG. 8 is a perspective view of a disposable nappy according to the invention.

Laboratory tests for measuring the thickness, relative density, strength in the longitudinal and cross directions and elongation in the longitudinal and transverse directions, are conducted in accordance with the ERT standards of the EDANA (European Disposables and Nonwovens Association), namely

Thickness:

The sample is conditioned for 24 hours and the test is carried out at 23° C. and at a relative humidity of 50%. The thickness of the nonwoven is measured by measuring the distance between a reference plate on which the nonwoven rests and a parallel pressing plate which applies a precise pressure to the surface which is being subjected to the test. The apparatus consists of two circular horizontal plates fixed to a frame. The upper plate moves vertically. It has a diameter of about 60 mm. The reference plate has a flat surface with a diameter at least 50 mm greater than that of the upper plate.

The test piece has dimensions of 100×100 mm, plus or minus 5 mm. A device is provided for measuring the distance between the plates when the latter have come together to the point where they apply a pressure of 0.02 kpa to the test piece.

Mass Per Square Metre (Basis Weight):

The sample is conditioned for 24 hours and the test is carried out at 23° C. and at a relative humidity of 50%. At least 3 samples with a surface area of at least 50,000 mm² are cut out. Each sample is weighed on laboratory scales having an accuracy of 0.1% of the mass of the samples weighed.

Relative Density:

The relative density is calculated from the thickness measured and the mass per square metre.

Mv=g/e×1000

Mv=relative density expressed in grams per cubic centimetre

g=mass per square metre (basis weight) of the nonwoven, expressed in grams per square metre

e=thickness of the nonwoven, expressed in millimetres

Shearing Force: FIG. 2

The sample is conditioned for 24 hours and the test is carried out at 23° C. and at a relative humidity of 50%.

For the test, use is made of a dynamometer comprising a set of fixed jaws 15 and a set of movable jaws 16 which move at a constant speed in the direction of the arrow. The jaws of the dynamometer have a useful width of 50 mm. The nonwoven 17 is placed on a board-bound plate in order to impart more rigidity to the said element, which is then fixed in the static jaw 15 of the dynamometer. The hook-carrier 18 is clamped in the movable jaw 16 after the hooks part has been located on the non-woven net 17 (size of the area of attachment: 25×13 mm).

The hooks used are of the type 963 marketed by the Aplix company. They comprise 140 hooks to the cm². Said hooks have a height of 0.36 mm and a head-width of 0.32 mm.

A distance, before traction, of 200 mm between the jaws, and a speed of traction of 200 mm/min is set up.

The equipment used gives the maximum tractive force. The latter corresponds to the breaking of attachment between the said two elements. 5 tests per sample are conducted, and the average of 5 tests is calculated.

Peeling Force: FIG. 3

Use is made of the same sample-conditioning conditions and the same dynamometer as in the case of the shearing test. The settings are identical to those for the shearing test. The sample of nonwoven 19 is fixed onto its T-shaped support 20 in the static jaw 21. The hook-carrier 22 is fixed onto its T-shaped support 23 and fixed in the movable jaw 24. 5 tests per sample are conducted, and the average of 5 tests is calculated.

The following examples and the comparative examples illustrate the invention.

### EXAMPLE 1

A net of nonwoven of 33 g/m² is produced at a speed of 133 metres per minute with the installation in conformity with the invention. The nonwoven in question is one which is made up of continuous PP filaments of 2.2 dtex. The said sheet of filaments thus produced is then consolidated by a first cylinder. The latter is covered with a nickel jacket micro-perforated with holes 300 microns in diameter, and comprises 100 holes per cm², distributed in a random manner. This first cylinder comprises two successive injectors delivering jets of water 120 microns in diameter and with a jet density of 1666 jets per metre and at pressures of 80 bars and then 120 bars, respectively. The net of filaments thus consolidated is transferred to the second cylinder. The latter is covered with a bronze weaving fabric of the net type comprising 9 threads per cm with a rectangular cross-section of 0.33 mm×0.64 mm in the machine direction and 9 threads per cm with a diameter of 0.46 mm in the transverse direction. The void fraction of the bronze fabric is 25% and its permeability to air is 875 CFM. Two injectors, which deliver jets of water 120 microns in diameter and with a jet density of 1666 jets per metre in the case of the first injector and 5000 jets per metre in the case of the second, act upon the pre-consolidated net of filaments at pressures of 80 bars and 130 bars respectively. The nonwoven is then dried in a dryer with air passing through at a temperature of 110° C. The nonwoven thus obtained has openings with average dimensions of 0.95×0.75 mm. The density of these openings is about 25 openings per cm². FIG. 4

### EXAMPLE 2

Example 1 is repeated as far as the second cylinder. Said second cylinder is covered with a jacket made of fine, non-marking metal fabric comprising 22 threads per cm with a diameter of 0.20 mm in the machine direction, and 20 threads per cm with a diameter of 0.20 mm in the transverse direction. On its surface, this metal fabric has hard raised parts which are made up of polymer and whose diameter is 2.4 mm and whose height is 1.25 mm. There are 4 raised parts per cm². The nonwoven thus obtained has openings of average dimensions of 2.2 mm and 4 openings per cm². FIG. 5

### EXAMPLE 3

Example 1 is repeated as far as the second cylinder. Said second cylinder is covered with a perforated metal jacket which is etched by electrochemical metal removal. It has perforations 0.5 mm in diameter and raised parts with a square cross-section with a side of 1.5 mm and a height of 1.5 mm. There are 9 raised parts per cm². The nonwoven thus obtained has 9 openings per cm² with a square shape and a side of 1.8 mm. FIG. 6

### EXAMPLE 4

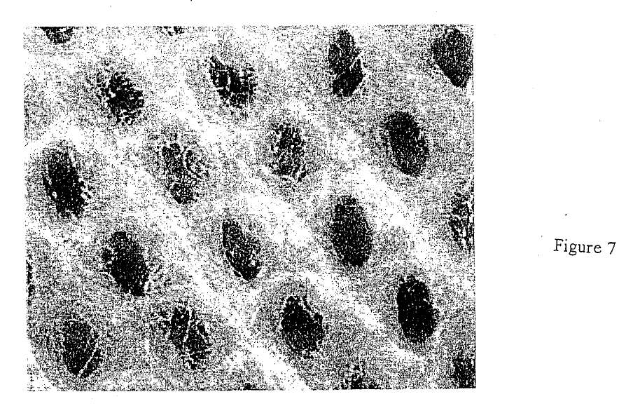

Example 1 is repeated as far as the second cylinder. Said second cylinder is covered with a perforated metal jacket which is etched by electrochemical metal removal. It has perforations 0.5 mm in diameter and raised parts with an ellipsoidal shape 2.0 mm by 0.75 mm in diameter and 1.5 mm in height. There are 18 raised parts per cm². The nonwoven thus obtained has 18 openings per cm² which are ellipsoidal in shape and 2.0 by 1.0 mm in diameter. FIG. 7

### COMPARATIVE EXAMPLE 1

A commercial 60 g/m² nonwoven for the area of attachment of a baby's nappy made up of PP filaments of 2.2 dtex. This nonwoven, which is described in Kimberly Clark's U.S. Pat. No. 6,921,570, is used in the fastening systems of diaper which are marketed under the “Huggies” trademark. This nonwoven, which is calendered negatively, that is to say the engraving on the calender produces consolidation on the net by fusion solely between the raised round shapes called “dots”. These raised dots are the points of attachment of the hooks belonging to the male part of the fastening systems.

### COMPARATIVE EXAMPLE 2

Example 1 is repeated as far as the second cylinder. But in the case of this example, the second cylinder is covered with the same micro-perforated jacket as the first cylinder. The injectors belonging to the second cylinder deliver jets of water 120 microns in diameter and with a jet density of 1666 jets per metre and at pressures of 80 bars and 130 bars respectively, onto the pre-consolidated net of filaments. The nonwoven is then dried in a dryer with air passing through at a temperature of 110° C. The nonwoven thus obtained has no perforations and has a smooth and uniform surface.

Summarising table

| | Example | Example | Example | Example | Comparative | Comparative |
|---|---|---|---|---|---|---|
| | 1 | 2 | 3 | 4 | example 1 | example 2 |
| Basis weight | 33 | 33 | 33 | 33 | 60 | 33 |
| (g/m²) | | | | | | |
| Thickness | 0.7 | 0.9 | 1.00 | 1.12 | 0.9 | 0.3 |
| (mm) | | | | | | |
| Density | 0.047 | 0.036 | 0.033 | 0.029 | 0.07 | 0.11 |
| (G/cm³) | | | | | | |
| Densities | 25 | 4 | 9 | 18 | 0 | 0 |
| (opening/ | | | | | | |
| cm²) | | | | | | |
| Dimensions | 0.95 × 0.75 | 2.6 × 2.2 | 1.8 × 1.8 | 2.0 × 1.0 | / | / |
| of openings | | | | | | |
| (mm) | | | | | | |
| Shearing force | 16.2 | 15.8 | 23.2 | 17.3 | 13.6 | 13.5 |
| (N) | | | | | | |
| Peeling force | 18.0 | 16.0 | 17.0 | 20.8 | 10.1 | 14.3 |
| (N) | | | | | | |
| Median-axis-to- | 0.95 | 2.6 | 3.8 | 2.0 | / | / |
| median axis | | | | | | |
| distance between 2 | | | | | | |
| openings (mm) | | | | | | |

The nonwovens used in accordance with the invention are, apart from their aesthetic qualities, more voluminous than the nonwovens on the market which are employed for the same applications. They have shearing-force and peeling-force performances which are far superior to those of the commercial nonwovens used for the same purposes, and that with weights per square metre which are much lower or even reduced by half. They are products which have a superior performance and a competitive price. They also make it possible to reduce the weight of nonwovens employed for making up diaper, a fact which constitutes one of the main expectations of the current market.

The diaper according to the invention in FIG. 8 comprises a main or clothing garment part 25 made of a nonwoven such as is used in accordance with the invention. Bonded to the outer face of this main part are two strips 26 which form, on their inner face, the male part of a hook-and-loop fastener and are intended to cooperate with the right-side face of the part 25 in order to fasten the diaper. The reverse-side face is covered, in its crotch part, with an absorbent core 27 made of absorbent fibres and super-absorbent powder. An elastic strip 28 improves the comfort of the nappy. A symbolic representation has been given, in broken lines, of a decorative 29 which is affixed to the reverse side of the main part 25 and can be seen, as a result of transparency.

1-10. (canceled)

11. Method for making a female part of a hook-and-loop fastener, which comprises providing a nonwoven which is made up of filaments; the cohesion of the nonwoven being provided solely by the entanglement of the filaments; which has a thickness of between 0.1 and 2.0 mm; which has a basis weight of between 10 and 100 g/m²; and which has openings numbering between 3 and 80 per cm², on the lateral walls of which the entangled filaments are intact

12. The method of claim 11, which comprises providing the nonwoven with a thickness of between 0.25 mm and 1.20 mm.

13. The method of claim 11, which comprises providing the nonwoven with a basis weight of between 15 and 40 g/m².

14. The method of claim 11, which comprises providing the nonwoven with openings numbering between 4 and 40 per cm².

15. The method of claim 11, wherein the filaments have a diameter of between 5 and 50 microns.

16. The method of claim 11, wherein the filaments have a diameter of between 10 and 30 microns.

17. The method of claim 11, wherein the filaments are made of a thermoplastic material selected from polyethylene, polypropylene, poly(ethylene terephthalate), polyamide, poly(lactic acid) or mixtures thereof.

18. The method of claim 11, wherein the openings are conical, having a cone angle of between 5 and 45°.

19. The method of claim 11, wherein the openings are disposed in an ordered manner.

20. The method of claim 11, wherein the pitch of the openings is between 1.2 times and 3 times, their smallest dimension.

21. The method of claim 11, wherein the openings extend in the plane of the nonwoven and have a largest dimension in the plane that is at least equal to one times the thickness of the nonwoven and at most equal to 3 times the thickness of the nonwoven.

22. The method of claim 11, wherein the nonwoven has a reverse-side face and a right-side face having a right-side surface area adapted to engage a male part of a hook and loop fastener, the male part having a male surface area for engagement with the right-side surface area, and the right-side surface area is more than two times larger than the male part surface area of the fastener.

23. The method of claim 11, wherein the filaments are displaced to form said lateral walls without filament breaking or cutting, and the lateral walls are thereby provided with an increased number of filaments at the lateral walls to enhance attachment of hooks to the lateral walls as compared with the number of filaments at locations in the nonwoven remote of the lateral walls.

24. A garment including a self-clothing part made of the nonwoven in accordance with claim 11, the nonwoven having a reverse-side face and a right-side face, the garment is fastenable by a hook-and-loop fastener having a female part, the female part of the fastener is provided by the right-side face of the self-clothing part of the garment.

25. A garment according to claim 24, characterised by a decoration affixed to the reverse-side face, which is visible through the right-side face of the nonwoven.

26. A garment according to claim 25, wherein the right-side face has a surface area which is more than two times, larger than a male part surface area of the fastener.

27. A method of making a garment that is closable by a hook and loop type fastener comprising the steps of forming the garment with a self-clothing part including the steps of:
forming the self-clothing part of a nonwoven made of filaments that are secured together solely by the entanglement of the filaments; the nonwoven having a thickness of between 0.1 and 2.0 mm and a basis weight of between 10 and 100 g/m²; displacing filaments to form openings through the nonwoven in an ordered pattern numbering between 3 and 80 openings per cm²; and
securing the self-clothing part to the garment to provide the female part or loop of the fastener with the openings arranged for receipt of and fastening engagement with the male part or hook of the fastener.

28. The method of claim 27, wherein the step of forming the openings includes providing the openings with lateral walls of intact filaments.

29. The method of claim 28, wherein the step of displacing filaments to form the openings includes increasing the number of filaments at the lateral walls as compared with the number of filaments at locations in the nonwoven remote of the lateral walls.

30. The method of claim 29, wherein the nonwoven has opposed sides, the openings are conically shaped through the thickness of the nonwoven with larger opening ends adjacent one side of the nonwoven to provide the female part or loop for receipt of and fastening engagement with the male part or hook of the fastener.
